(19) United States
(12) Patent Application Publication
(10) Pub. No.: US 2025/0199572 A1
(43) Pub. Date: Jun. 19, 2025

(54) FOLDABLE ELECTRONIC DEVICE INCLUDING SEGMENTED ANTENNA

(71) Applicant: Samsung Electronics Co., Ltd., Suwon-si (KR)

(72) Inventors: Bomi LEE, Suwon-si (KR); Junhee HAN, Suwon-si (KR); Jeongseob KIM, Suwon-si (KR)

(21) Appl. No.: 19/054,213

(22) Filed: Feb. 14, 2025

Related U.S. Application Data
(63) Continuation of application No. PCT/KR2023/008634, filed on Jun. 21, 2023.

(30) Foreign Application Priority Data
Aug. 19, 2022 (KR) 10-2022-0104190
Sep. 2, 2022 (KR) 10-2022-0111744

(51) Int. Cl. G06F 1/16; H01Q 1/22; H01Q 21/28

(52) U.S. Cl. CPC G06F 1/1618; G06F 1/1626; H01Q 1/2291; H01Q 21/28

(57) ABSTRACT

An electronic device is provided. The electronic device includes a first housing including a sidewall that includes conductive portions spaced apart from each other and non-conductive portions disposed between the conductive portions, a second housing including a conductive sidewall having a length substantially equal to a length of the sidewall, a hinge structure rotatably connecting the first housing and the second housing, a ground portion disposed within the second housing, memory storing one or more computer programs, and one or more processors disposed within the first housing and being electrically connected to at least one of the conductive portions operating as a radiator of an antenna for communicating with an external electronic device, wherein the one or more computer programs include computer-executable instructions that, when executed by the one or more processors individually or collectively, cause the electronic device to electrically disconnect the conductive side wall from the grounding portion within the second housing when the electronic device is in a folded state in which a first surface of the first housing and a second surface of the second housing face different directions, and electrically connect the conductive side wall to the grounding portion within the second housing when the electronic device is in an unfolded state in which a direction faced by the first surface and a direction faced by the second surface are a same direction.

### CROSS-REFERENCE TO RELATED APPLICATION(S)

This application is a continuation application, claiming priority under 35 U.S.C. § 365(c), of an International application No. PCT/KR2023/008634, filed on Jun. 21, 2023, which is based on and claims the benefit of a Korean patent application number 10-2022-0104190, filed on Aug. 19, 2022, in the Korean Intellectual Property Office, and of a Korean patent application number 10-2022-0111744, filed on Sep. 2, 2022, in the Korean Intellectual Property Office, the disclosure of each of which is incorporated by reference herein in its entirety.

### BACKGROUND

### 1. Field

The disclosure relates to a foldable electronic device including a segmented antenna.

### 2. Description of Related Art

An electronic device may communicate with an external electronic device, by using an antenna for wireless communication. The electronic device such as a smart phone, a tablet, or a notebook computer may include a plurality of antennas for various types of communication with the external electronic device. In order to improve portability of the electronic device, a foldable electronic device is being developed. The foldable electronic device may provide a structure for reducing a performance change of the antenna according to a folded state and an unfolded state.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a foldable electronic device including a segmented antenna.

Additional aspects will be set forth in part in the description which follows and, in part, will be apparent from the description, or may be learned by practice of the presented embodiments.

In accordance with an aspect of the disclosure, an electronic device is provided. The electronic device includes a first housing including a side wall that includes conductive portions spaced apart from each other and non-conductive portions disposed between the conductive portions, a second housing including a conductive side wall having a length substantially equal to a length of the side wall, a hinge structure rotatably connecting the first housing and the second housing, a grounding portion disposed within the second housing, memory storing one or more computer programs, and one or more processors disposed within the first housing and being electrically connected to at least one of the conductive portions operating as a radiator of an antenna for communicating with an external electronic device, wherein the one or more computer programs include computer-executable instructions that, when executed by the one or more processors individually or collectively, cause the electronic device to electrically disconnect the conductive side wall from the grounding portion within the second housing when the electronic device is in a folded state in which a first surface of the first housing and a second surface of the second housing face different directions, and electrically connect the conductive side wall to the grounding portion within the second housing when the electronic device is in an unfolded state in which a direction faced by the first surface and a direction faced by the second surface are a same direction.

In accordance with another aspect of the disclosure, an electronic device is provided. The electronic device includes a first housing including a side wall, the side wall including a first conductive portion, a second conductive portion facing the first conductive portion, and a third conductive portion disposed between the first conductive portion and the second conductive portion and spaced apart from the first conductive portion and the second conductive portion, a second housing including a conductive side wall having a length substantially equal to a length of the side wall, a hinge structure rotatably connecting the first housing and the second housing, a grounding portion disposed within the second housing, a switch electrically connected to each of the grounding portion and the conductive side wall, memory storing one or more computer programs, and one or more processors disposed within the first housing and being electrically connected to at least one of the first conductive portion, the second conductive portion, or the third conductive portion which operates as a radiator of an antenna for communicating with an external electronic device, wherein the one or more computer programs include computer-executable instructions that, when executed by the one or more processors individually or collectively, cause the electronic device to electrically disconnect the conductive side wall from the grounding portion within the second housing through the switch when the electronic device is in a folded state in which a first surface of the first housing and a second surface of the second housing face different directions, and electrically connect the conductive side wall to the grounding portion within the second housing through the switch when the electronic device is in an unfolded state in which a direction faced by the first surface and a direction faced by the second surface are a same direction.

In accordance with another aspect of the disclosure, one or more non-transitory computer-readable storage media storing one or more computer programs including computer-executable instructions that, when executed by one or more processors of an electronic device individually or collectively, cause the electronic device to perform operations, the electronic device including a first housing including a side wall that includes conductive portions spaced apart from each other and non-conductive portions disposed between the conductive portions, a second housing including a conductive side wall having a length substantially equal to a length of the side wall, a hinge structure rotatably connecting the first housing and the second housing, and a grounding portion disposed within the second housing, are provided. The operations include electrically disconnecting the conductive side wall from the grounding portion within the second housing when the electronic device is in a folded state in which a first surface of the first housing and a second surface of the second housing face different directions, and electrically connecting the conductive side wall to the grounding portion within the second housing when the electronic device is in an unfolded state in which a direction faced by the first surface and a direction faced by the second surface are a same direction.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device for supporting legacy network communication and 5G network communication according to an embodiment of the disclosure;

FIG. 3A indicates a first state of an electronic device according to an embodiment of the disclosure;

FIG. 3B indicates a second state of an electronic device according to an embodiment of the disclosure;

FIG. 4A indicates a disposition of an antenna in a first state of an electronic device according to an embodiment of the disclosure;

FIG. 4B indicates a disposition of an antenna in a second state of an electronic device according to an embodiment of the disclosure;

FIG. 5A indicates a first state of an electronic device including a display according to an embodiment of the disclosure;

FIG. 5B indicates a second state of an electronic device including a display according to an embodiment of the disclosure;

FIGS. 6 and 7 indicate a connection state between an antenna and a switch of an electronic device according to various embodiments of the disclosure;

FIG. 8 indicates a disposition of a conductive portion and a non-conductive portion of an electronic device according to an embodiment of the disclosure; and

FIG. 9 indicates graphs indicating antenna performance of electronic devices according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

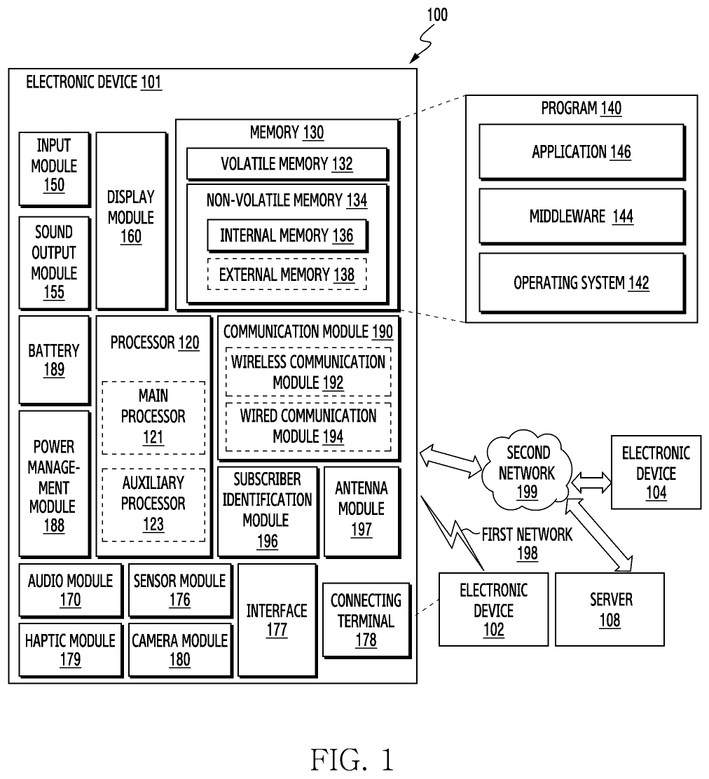

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include internal memory 136 and external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices (e.g., electronic devices 102 and 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

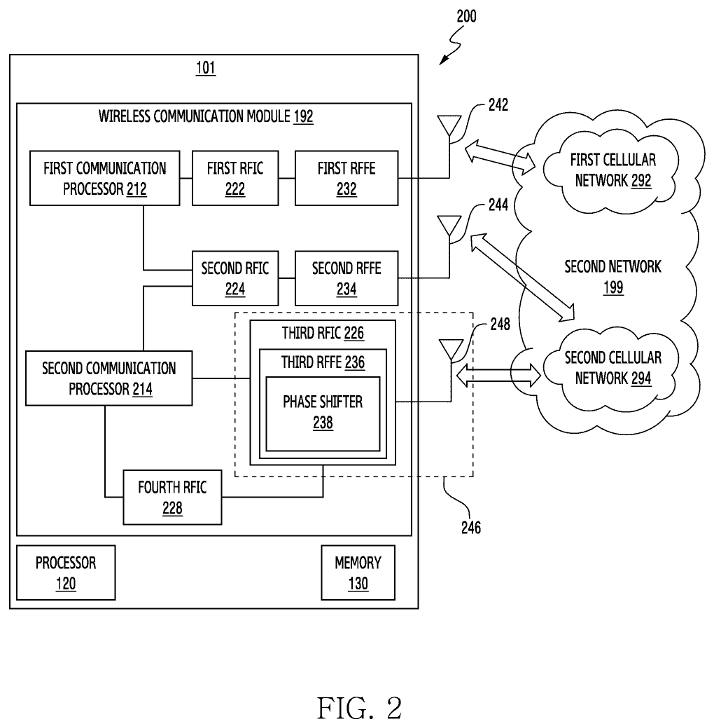

FIG. 2 is a block diagram of an electronic device for supporting legacy network communication and 5G network communication, according to an embodiment of the disclosure.

Referring to FIG. 2, block diagram 200 illustrates that an electronic device 101 may include a first communication processor 212, a second communication processor 214, a first radio frequency integrated circuit (RFIC) 222, a second RFIC 224, and a third RFIC 226, a fourth RFIC 228, a first radio frequency front end (RFFE) 232, a second RFFE 234, a first antenna module 242, a second antenna module 244, and an antenna 248. The electronic device 101 may further include the processor 120 and the memory 130. The second network 199 may include a first cellular network 292 and a second cellular network 294. According to another embodiment, the electronic device 101 may further include at least one of the components illustrated in FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may constitute at least a part of a wireless communication module 192. According to another embodiment, the fourth RFIC 228 may be omitted or may be included as a part of the third RFIC 226.

The first communication processor 212 may support the establishment of a communication channel of a band to be used for wireless communication with the first cellular network 292 and legacy network communication through the established communication channel. According to various embodiments, the first cellular network 292 may be a legacy network including a 2nd generation (2G), 3rd generation (3G), 4th generation (4G), and/or long-term evolution (LTE) network. The second communication processor 214 may support the establishment of a communication channel corresponding to a specified band (e.g., approximately 6 gigahertz (GHz) to 60 GHz) among bands to be used for wireless communication with the second cellular network 294, and 5G network communication through the established communication channel. According to various embodiments, the second cellular network 294 may be a 5G network defined by 3rd generation partnership project (3GPP). Additionally, according to an embodiment, the first communication processor 212 or the second communication processor 214 may support the establishment of a communication channel corresponding to another specified band (e.g., approximately 6 GHz or less) among bands to be used for wireless communication with the second cellular network 294, and 5G network communication through the established communication channel. According to an embodiment, the first communication processor 212 and the second communication processor 214 may be implemented in a single chip or a single package. According to various embodiments, the first communication processor 212 or the second communication processor 214 may be formed with the processor 120, the auxiliary processor 123 of FIG. 1, or the communication module 190 in a single chip or a single package.

Upon transmission, the first RFIC 222 may convert a baseband signal generated by the first communication processor 212 into a radio frequency (RF) signal of approximately 700 megahertz (MHz) to approximately 3 GHz used in the first cellular network 292 (e.g., a legacy network). Upon reception, an RF signal may be obtained from the first cellular network 292 (e.g., a legacy network) through an antenna (e.g., the first antenna module 242), and may be preprocessed through an RFFE (e.g., the first RFFE 232). The first RFIC 222 may convert the preprocessed RF signal into a baseband signal so as to be processed by the first communication processor 212.

Upon transmission, the second RFIC 224 may convert a baseband signal generated by the first communication processor 212 or the second communication processor 214 into an RF signal (hereinafter, referred to as a 5G Sub6 RF signal) of the Sub6 band (e.g., approximately 6 GHz or less) used in the second cellular network 294 (e.g., the 5G network). Upon reception, a 5G Sub6 RF signal may be obtained from the second cellular network 294 (e.g., the 5G network) through an antenna (e.g., the second antenna module 244), and may be preprocessed through an RFFE (e.g., the second RFFE 234). The second RFIC 224 may convert the preprocessed 5G Sub6 RF signal into a baseband signal so as to be processed by a corresponding one of the first communication processor 212 or the second communication processor 214.

The third RFIC 226 may convert a baseband signal generated by the second communication processor 214 into an RF signal (hereinafter, referred to as a 5G Above6 RF signal) of the 5G Above6 band (e.g., approximately 6 GHz to approximately 60 GHz) to be used in the second cellular network 294 (e.g., the 5G network). Upon reception, a 5G Above6 RF signal may be obtained from the second cellular network 294 (e.g., the 5G network) through an antenna (e.g., the antenna 248), and may be preprocessed through a third RFFE 236. For example, the third RFFE 236 may perform preprocessing of the signal by using a phase shifter 238. The third RFIC 226 may convert the preprocessed 5G Above6 RF signal into a baseband signal so as to be processed by the second communication processor 214. According to an embodiment, the third RFFE 236 may be formed as a part of the third RFIC 226.

According to an embodiment, the electronic device 101 may include the fourth RFIC 228 separately from or at least as a part of the third RFIC 226. In this case, the fourth RFIC 228 may convert the baseband signal generated by the second communication processor 214 into an RF signal (hereinafter, referred to as an intermediate frequency (IF) signal) of an intermediate frequency band (e.g., approximately 9 GHz to approximately 11 GHz), and then transmit the IF signal to the third RFIC 226. The third RFIC 226 may convert the IF signal into a 5G Above6 RF signal. Upon reception, a 5G Above6 RF signal may be received from the second cellular network 294 (e.g., the 5G network) through an antenna (e.g., the antenna 248), and may be converted into an IF signal by the third RFIC 226. The fourth RFIC 228 may convert the IF signal into the baseband signal so as to be processed by the second communication processor 214.

According to an embodiment, the first RFIC 222 and the second RFIC 224 may be implemented as a single chip or at least a part of a single package. According to an embodiment, the first RFFE 232 and the second RFFE 234 may be implemented as a single chip or at least a part of a single package. According to an embodiment, at least one of the first antenna module 242 or the second antenna module 244 may be omitted or combined with another antenna module to process RF signals of a plurality of corresponding bands.

According to an embodiment, the third RFIC 226 and the antenna 248 may be disposed on the same substrate to form a third antenna module 246. For example, the wireless communication module 192 or the processor 120 may be disposed on a first substrate (e.g., a main PCB). In this case, the third RFIC 226 may be disposed in a partial region (e.g., the lower surface) of a second substrate (e.g., a sub PCB) separate from the first substrate, and the antenna 248 may be disposed in another partial region (e.g., the upper surface) to form the third antenna module 246. According to an embodiment, the antenna 248 may include, for example, an antenna array that may be used for beamforming. By disposing the third RFIC 226 and the antenna 248 on the same substrate, it is possible to reduce the length of the transmission line therebetween. This, for example, may reduce the loss (e.g., attenuation) of a signal in a high frequency band (e.g., approximately 6 GHz to approximately 60 GHz) used for 5G network communication by the transmission line. Accordingly, the electronic device 101 may improve the quality or speed of communication with the second cellular network 294 (e.g., the 5G network).

The second cellular network 294 (e.g., the 5G network) may be operated independently of (e.g., Stand-Alone (SA)) or operated to be connected to (e.g., Non-Stand Alone (NSA)) the first cellular network 292 (e.g., the legacy network). For example, in the 5G network, there may be only an access network (e.g., 5G radio access network (RAN) or next-generation RAN (NG RAN)) and no core network (e.g., next-generation core (NGC)). In this case, after accessing the access network of the 5G network, the electronic device 101 may access an external network (e.g., the Internet) under the control of a core network (e.g., evolved packed core (EPC)) of the legacy network. Protocol information for communication with the legacy network (e.g., LTE protocol information) or protocol information for communication with the 5G network (e.g., New Radio (NR) protocol information) may be stored in the memory 230 and may be accessed by other components (e.g., the processor 120, the first communication processor 212, or the second communication processor 214).

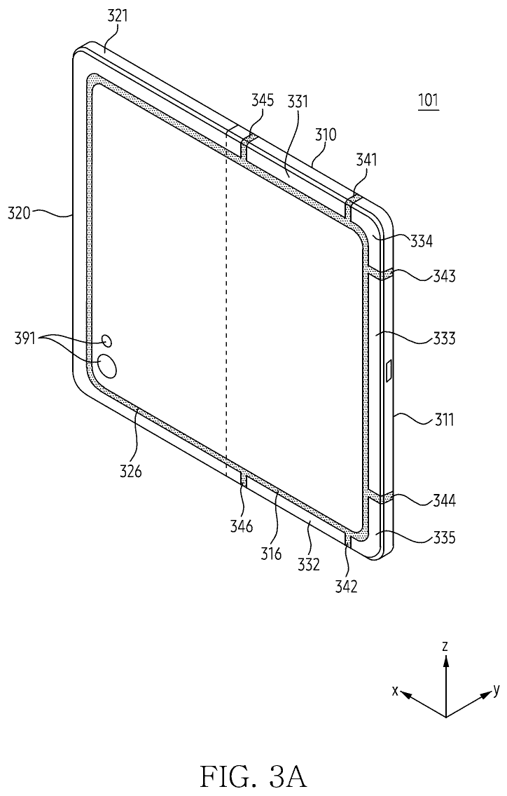

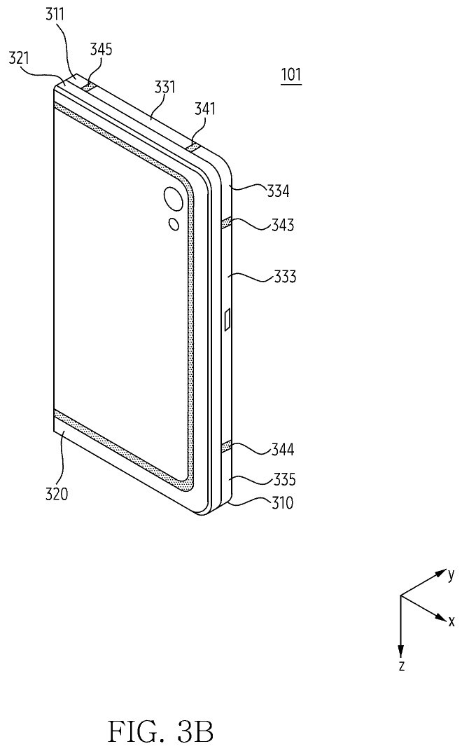

FIG. 3A indicates a first state of an electronic device according to an embodiment of the disclosure. FIG. 3B indicates a second state of an electronic device according to an embodiment of the disclosure.

Referring to FIGS. 3A and 3B, an electronic device 101 may include a first housing 310 and a second housing 320. The electronic device 101 may be an electronic device that provides a large screen. For example, the electronic device 101 may be a notebook computer or a tablet PC. However, it is not limited thereto.

According to an embodiment, the electronic device 101 providing the large screen may provide an unfolded state (an unfolding state) or a folded state (a folding state). For example, the electronic device 101 may provide the folded state in which a surface of the first housing 310 and a surface of the second housing 320 face each other. The electronic device 101 may provide the unfolded state in which the surface of the first housing 310 and the surface of the second housing 320 face the same direction. The electronic device 101 may provide an intermediate state that changes from the folded state to the unfolding state or changes from the unfolded state to the folded state. The intermediate state may be a free stop state in which the first housing 310 and the second housing 320 may maintain an angle within a preset range.

According to an embodiment, the first housing 310 may include a first side wall 311. The first side wall 311 may form a portion of an exterior of the electronic device 101. The first side wall 311 may form a side surface of the first housing 310. According to an embodiment, the first side wall 311 may include a plurality of conductive portions 331, 332, 333, 334, and 335 and a plurality of non-conductive portions 341, 342, 343, 344, 345, and 346. The plurality of non-conductive portions 341, 342, 343, 344, 345, and 346 may be disposed between the plurality of conductive portions 331, 332, 333, 334, and 335. At least a portion of the plurality of conductive portions 331, 332, 333, 334, and 335 may operate as an antenna radiator. For example, a first conductive portion 331 may form at least a portion of a first edge of the first housing 310. A second conductive portion 332 may form at least a portion of a second edge facing the first edge of the first housing 310. A third conductive portion 333 may form at least a portion of a third edge of the first housing 310 disposed between the first edge and the second edge. A fourth conductive portion 334 may extend from the first conductive portion 331 to the third conductive portion 333. The fourth conductive portion 334 may form a portion of the first edge and a portion of the third edge. A fifth conductive portion 335 may extend from the second conductive portion 332 to the third conductive portion 333. The fifth conductive portion 335 may form a portion of the second edge and another portion of the third edge.

According to an embodiment, a first non-conductive portion 341 may be disposed between the first conductive portion 331 and the fourth conductive portion 334. A second non-conductive portion 342 may be disposed between the second conductive portion 332 and the fifth conductive portion 335. A third non-conductive portion 343 may be disposed between the third conductive portion 333 and the fourth conductive portion 334. A fourth non-conductive portion 344 may be disposed between the third conductive portion 333 and the fifth conductive portion 335.

According to an embodiment, the first housing 310 may include a first segmented portion 316 connected to the first non-conductive portion 341, the second non-conductive portion 342, the third non-conductive portion 343, the fourth non-conductive portion 344, a fifth non-conductive portion 345, and the sixth non-conductive portion 346. The first segmented portion 316 may extend along the first side wall 311 of the first housing 310.

According to an embodiment, the second housing 320 may include a second side wall 321. The second side wall 321 may form the portion of the exterior of the electronic device 101. The second side wall 321 may be entirely formed of a conductive material. The second side wall 321 may be referred to as a conductive side wall in terms of being formed of a conductive material. For example, the second side wall 321 may form a side surface of the second housing 320. The second housing 320 may include a second segmented portion 326. The second segmented portion 326 may disconnect the second side wall 321 from a remaining portion of the second housing 320 except for the second side wall 321. For example, the second side wall 321 may be physically and electrically disconnected from the remaining portion of the second housing 320. The remaining portion of the second housing 320 may operate as a grounding portion of the electronic device 101. For example, the remaining portion of the second housing 320 may be electrically connected to a grounding layer of a printed circuit board in the electronic device 101. The second segmented portion 326 may disconnect the second side wall 321 from the remaining portion of the second housing 320. According to an embodiment, the second housing 320 may further include an optical input device 391. The optical input device 391 may include a camera or an optical sensor.

According to an embodiment, as the first housing 310 and the second housing 320 of the electronic device 101 (e.g., the electronic device 101 of FIG. 3A) in the unfolded state do not face each other and form a plane, the conductive portions 331, 332, 333, 334, and 335 may not overlap the second side wall 321. At least a portion of the conductive portions 331, 332, 333, 334, and 335 may operate as the antenna radiator. In the unfolded state, the conductive portions 331, 332, 333, 334, and 335 operating as the antenna radiator may be relatively less affected by the second side wall 321 than in the folded state.

According to an embodiment, as the first housing 310 and the second housing 320 of the electronic device 101 in the folded state face each other, the conductive portions 331, 332, 333, 334, and 335 may face the second side wall 321. A length of the second side wall 321 may be substantially equal to a sum of lengths of the conductive portions 331, 332, 333, 334, and 335 and lengths of the non-conductive portions 341, 342, 343, 344, 345, and 346. A shape of the second side wall 321 may be substantially the same as a shape of the first side wall 311. In the folded state, the first housing 310 and the second housing 320 of the electronic device 101 may face each other. Based on facing of the first housing 310 and the second housing 320, the second side wall 321 may face the first side wall 311. The conductive portions 331, 332, 333, 334, and 335 of the first side wall 311 operating as the antenna radiator may be coupled to the second side wall 321. For example, in the folded state, when the conductive portions 331, 332, 333, 334, and 335 are used as the antenna radiator, the second side wall 321 connected to the grounding portion may be coupled to the conductive portions 331, 332, 333, 334, and 335. In the folding state, radiation performance of the antenna using the conductive portions 331, 332, 333, 334, and 335 may be changed, based on the coupling. In order to reduce the change in the radiation performance, the electronic device 101 may be configured to electrically short the second side wall 321 with the grounding portion. In the unfolded state, the second side wall 321 connected to the grounding portion may discharge static electricity from the second side wall 321 to the grounding portion to prevent electrostatic discharge immunity (ESD). In the folded state, since current of the conductive portions 331, 332, 333, 334, and 335 is more easily induced to the second side wall 321 than in the unfolded state, the second side wall 321 may be disconnected from the grounding portion to improve the radiation performance.

According to the above-described embodiment, the electronic device 101 may electrically disconnect the second side wall 321 from the grounding portion when folded, and electrically connect the second side wall 321 to the grounding portion when unfolded. The electronic device 101 may discharge the static electricity from the second side wall 321 through the grounding portion in the unfolded state. The electronic device 101 may improve the radiation performance of the conductive portions 331, 332, 333, 334, and 335 operating as the antenna radiator through electrical disconnection between the grounding portion and the second side wall 321 in the folded state.

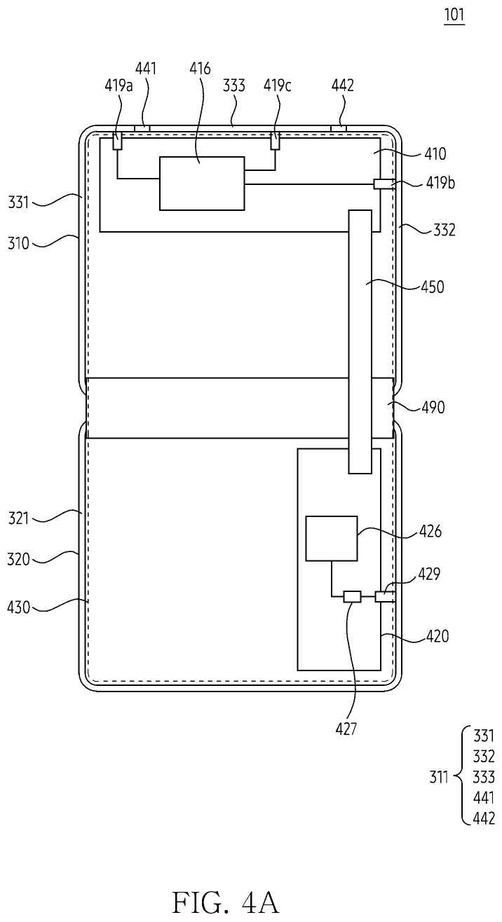

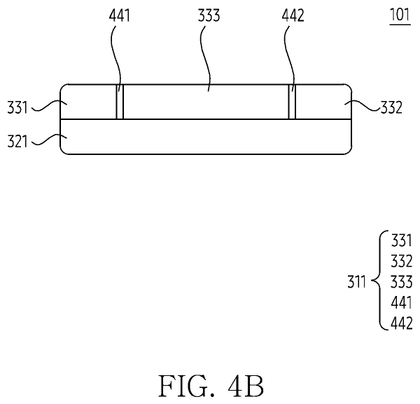

FIG. 4A indicates a disposition of an antenna in a first state of an electronic device according to an embodiment of the disclosure. FIG. 4B indicates a disposition of an antenna in a second state of an electronic device according to an embodiment of the disclosure.

Referring to FIGS. 4A and 4B, a first housing 310 may include a first side wall 311. A second housing 320 may include a second side wall 321. The first side wall 311 may include a plurality of conductive portions 331, 332, and 333 and a plurality of non-conductive portions 441 and 442. The number of the plurality of conductive portions 331, 332, and 333 and the non-conductive portions 441 and 442 may be determined based on the number of frequency bands used as an antenna radiator. A length or a shape of the plurality of conductive portions 331, 332, and 333 may be determined based on the frequency band used as the antenna radiator.

According to an embodiment, the first housing 310 and the second housing 320 may be similar to the first housing and second housing of FIGS. 3A and 3B. This overlapping description is omitted.

According to an embodiment, the first housing 310 may be rotatably connected with respect to the second housing 320. The first housing 310 and the second housing 320 may be rotatably connected to each other through a hinge structure 490. The hinge structure 490 may be connected to the first side wall 311 and the second side wall 321. The hinge structure 490 may be connected to an end of the first conductive portion 331 and an end of the second conductive portion 332 respectively.

According to an embodiment, the electronic device 101 may further include a display 430. The display 430 may be disposed across the hinge structure 490. The display 430 may be disposed on the first housing 310 and the second housing 320. The display 430 may be deformed with respect to a folding axis of the hinge structure 490 according to movement of the first housing 310 and the second housing 320. The display 430 may be referred to as a flexible display in terms of deformability.

According to an embodiment, the electronic device 101 may include a first printed circuit board 410, a second printed circuit board 420, and a flexible printed circuit board 450. The first printed circuit board 410 may include a processor 416. The processor 416 may be the processor 120 of FIG. 1, the first communication processor 212 or the second communication processor 214 of FIG. 2, or a wireless communication circuit. The processor 416 may communicate with an external electronic device (e.g., the electronic device 104), by using at least one of the first conductive portion 331, the second conductive portion 332, and the third conductive portion 333 as the antenna radiator.

According to an embodiment, the processor 416 may be electrically connected to the first conductive portion 331 through a first connection member 419a. The processor 416 may be electrically connected to the second conductive portion 332 through a second connection member 419b. The processor 416 may be electrically connected to the third conductive portion 333 through a third connection member 419c. The first connection member 419a, the second connection member 419b, and the third connection member 419c may be electrically connected to the printed circuit board. The first connection member 419a, the second connection member 419b, and the third connection member 419c may include a contact, a connector, or a C-clip.

According to an embodiment, a portion of the first side wall 311 from among the first side wall 311 of the first housing 310 and the second side wall 321 of the second housing 320 may be configured to operate as the radiator of the antenna for communicating with the external electronic device. For example, the conductive portions 331, 332, and 333 of the first side wall 311 may be electrically connected to the processor 416. The second side wall 321 may not be electrically connected to the processor 416. For example, the conductive portions 331, 332, and 333 may be connected to a power supply point that may receive a power supply signal from the processor 416, and the second side wall 321 may not be connected to the power supply point.

According to an embodiment, the second printed circuit board 420 may include a grounding portion 426 and a switch 427. The second printed circuit board 420 may be electrically connected to the second side wall 321 through a fourth connection member 429. The grounding portion 426 may mean a grounding layer disposed on the second printed circuit board 420. The grounding portion 426 may be connected to a mechanism (e.g., a frame, a bracket, or a portion of a housing) for grounding disposed outside the second printed circuit board 420.

According to an embodiment, the switch 427 may selectively connect the grounding portion 426 and the second side wall 321. For example, the processor 416 may connect the grounding portion 426 and the second side wall 321 through the switch 427, based on a state of the electronic device 101. For example, through the switch 427, the processor 416 may electrically disconnect the second side wall 321 from the grounding portion when folded, based on the folded state of the electronic device 101 and electrically connect the second side wall 321 to the grounding portion 426, based on the folding of the electronic device 101.

According to an embodiment, the first printed circuit board 410 and the second printed circuit board 420 may be electrically connected through the flexible printed circuit board 450. The flexible printed circuit board 450 may be disposed across the hinge structure 490. The flexible printed circuit board 450 may be deformed according to the state of the electronic device 101.

According to the above-described embodiment, through the switch 427, the electronic device 101 may electrically disconnect the second side wall 321 from the grounding portion 426 when folded and electrically connect the second side wall 321 to the grounding portion 426 when unfolded. The electronic device 101 may discharge static electricity from the second side wall 321, through connection between the second side wall 321 and the grounding portion 426 in the unfolded state. The electronic device 101 may improve radiation performance of the conductive portions 331, 332, 333, 334, and 335 operating as the antenna radiator through electrical disconnection between the grounding portion 426 and the second side wall 321 in the folded state.

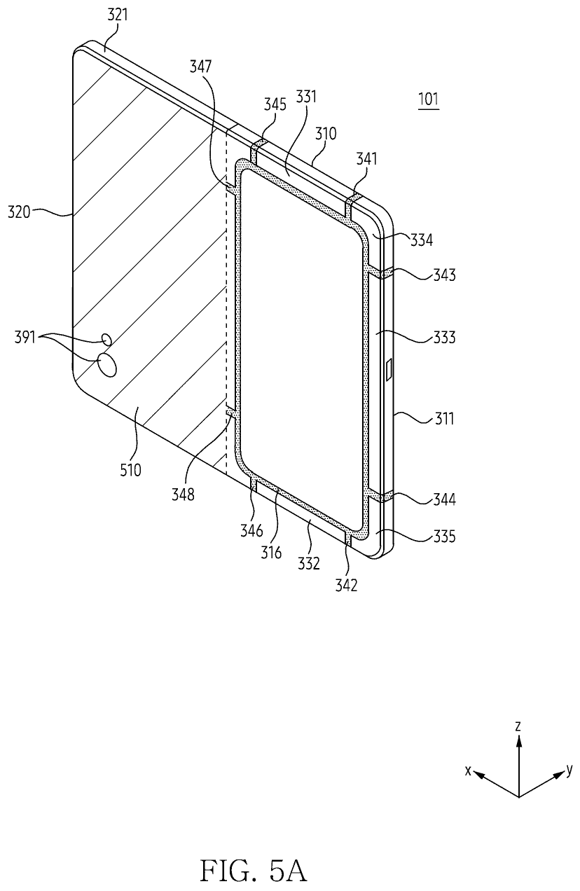

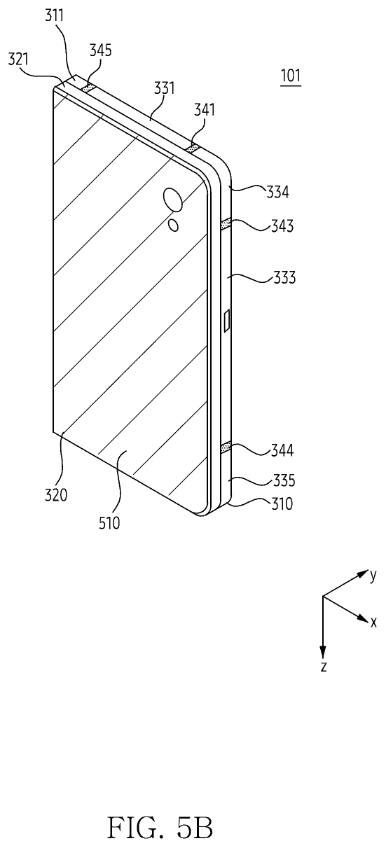

FIG. 5A indicates a first state of an electronic device including a display according to an embodiment of the disclosure. FIG. 5B indicates a second state of an electronic device including a display according to an embodiment of the disclosure.

Referring to FIGS. 5A and 5B, a first housing 310 may include a first side wall 311. The first side wall 311 may form a portion of an exterior of an electronic device 101. According to an embodiment, the first side wall 311 may include a plurality of conductive portions 331, 332, 333, 334, and 335 and a plurality of non-conductive portions 341, 342, 343, 344, 345, 346, 347, and 348. The plurality of non-conductive portions 341, 342, 343, 344, 345, 346, 347, and 348 may be disposed between the plurality of conductive portions 331, 332, 333, 334, and 335.

According to an embodiment, the plurality of non-conductive portions and the plurality of conductive portions may be the same as or similar to the plurality of non-conductive portions and the plurality of conductive portions of FIGS. 3A, 3B, 4A, and 4B. Content overlapping a description of the plurality of non-conductive portions and the plurality of conductive portions may be omitted.

According to an embodiment, the first housing 310 may further include a seventh non-conductive portion 347, and a first segmented portion 316. The first side wall 311 may be disposed along a remaining edges of the first housing 310 except for an edge of the first housing 310 facing a hinge structure (e.g., the hinge structure 490 of FIG. 4A). The seventh non-conductive portion 347 and an eighth non-conductive portion 348 may be disposed in the edge of the first housing 310. The first segmented portion 316 may be connected to the plurality of non-conductive portions 341, 342, 343, 344, 345, 346, 347, and 348. The first segmented portion 316 may be disposed along the edge of the first housing 310.

According to an embodiment, the electronic device 101 may further include an external display 510. The external display 510 may be disposed in the second housing 320. For example, the display 430 may be disposed on a surface of the first housing 310 and a surface of the second housing 320, and the external display 510 may be disposed on another surface of the second housing 320 facing the surface of the second housing 320.

The optical input device 391 may be exposed on the surface on which the external display 510 is disposed. A position of the optical input device 391 is not limited thereto, and may be disposed in the first housing 310. For example, the optical input device 391 may be disposed on the first housing 310 or the second housing 320. In case that the optical input device 391 is disposed on the second housing 320 in which the external display 510 is disposed, the external display 510 may include a structure (e.g., an opening or a notch) for the optical input device 391. According to an embodiment, the optical input device 391 may be disposed below the external display 510. The external display 510 may change a configuration of a pixel differently in an area in which the optical input device 391 is disposed. For example, pixel density in the area of the external display 510 in which the optical input device 391 is disposed may be lower than pixel density within a remaining area of the external display 510.

According to an embodiment, the conductive portions 331, 332, 333, 334, and 335 used as the antenna radiator may be disposed in another housing different from the housing in which the external display 510 is disposed. For example, the conductive portions 331, 332, 333, 334, and 335 may be disposed in the first housing 310, and the external display 510 may be disposed in the second housing 320. In order to facilitate transmission of an electromagnetic wave in the conductive portions 331, 332, 333, 334, and 335 used as the antenna radiator, the conductive portions 331, 332, 333, 334, and 335 may be disposed in a housing different from the external display 510. The conductive portions 331, 332, 333, 334, and 335 may reduce noise of the external display 510.

According to an embodiment, as the first housing 310 and the second housing 320 of the electronic device 101 (e.g., the electronic device 101 of FIG. 3A) in the unfolded state do not face each other and form a plane, the conductive portions 331, 332, 333, 334, and 335 may not overlap the second side wall 321. At least a portion of the conductive portions 331, 332, 333, 334, and 335 may operate as the antenna radiator. In the unfolded state, the conductive portions 331, 332, 333, 334, and 335 operating as the antenna radiator may be relatively less affected by the second side wall 321 than in the folded state.

According to an embodiment, as the first housing 310 and the second housing 320 of the electronic device 101 in the folded state face each other, the conductive portions 331, 332, 333, 334, and 335 may face the second side wall 321. A length of the second side wall 321 may be substantially equal to a sum of lengths of the conductive portions 331, 332, 333, 334, and 335 and lengths of the non-conductive portions 341, 342, 343, 344, 345, and 346. In the folded state, the first housing 310 and the second housing 320 of the electronic device 101 may face each other. Based on facing of the first housing 310 and the second housing 320, the second side wall 321 may face the first side wall 311. In the folded state, the external display 510 of the electronic device 101 may overlap the first housing 310.

According to an embodiment, the conductive portions 331, 332, 333, 334, and 335 of the first side wall 311 operating as the antenna radiator may be coupled to the second side wall 321. For example, when conductive portions 331, 332, 333, 334, and 335 are used as the antenna radiator in the folded state, the electromagnetic wave transmitted from the conductive portions 331, 332, 333, 334, and 335 through the second side wall 321 connected to the grounding portion may be induced. In the folded state, due to inducement of the electromagnetic wave, radiation performance of the antenna using the conductive portions 331, 332, 333, 334, and 335 may be degraded than in the unfolded state. In order to reduce deterioration of the radiation performance, the electronic device 101 may be configured to electrically short the second side wall 321 with the grounding portion in the folded state.

According to an embodiment, when viewing the external display 510 from above, an edge of the external display 510 may be spaced apart from the conductive portions 331, 332, 333, 334, and 335. The external display 510 may be spaced apart from the second side wall 321 of the second housing 320. For example, the external display 510 may be spaced apart from an edge of the second housing 320. In the folded state such as the electronic device 101 of FIG. 5B, when viewing the second housing 320 from above, the external display 510 may not overlap the first side wall 311. The external display 510 may be disposed to minimize influence on the conductive portions 331, 332, 333, 334, and 335 operating as the antenna radiator.

According to the above-described embodiment, the electronic device 101 may reduce influence of the antenna due to the noise of the external display 510 by disposing the external display 510 and the conductive portions 331, 332, 333, 334, and 335 in different housings. By connecting or disconnecting the second side wall 321 to the grounding portion according to the unfolded state and the folded state, the electronic device 101 may discharge static electricity in the unfolded state and improve the radiation performance of the antenna in the folded state.

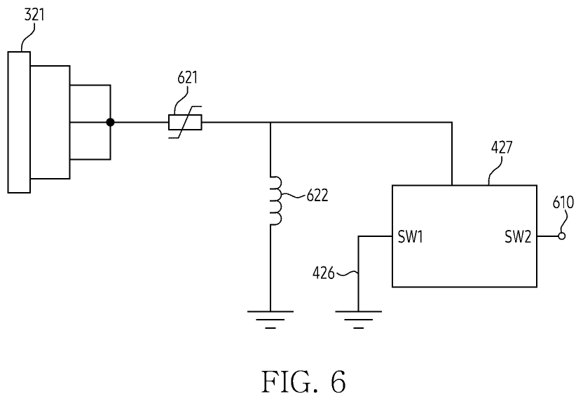

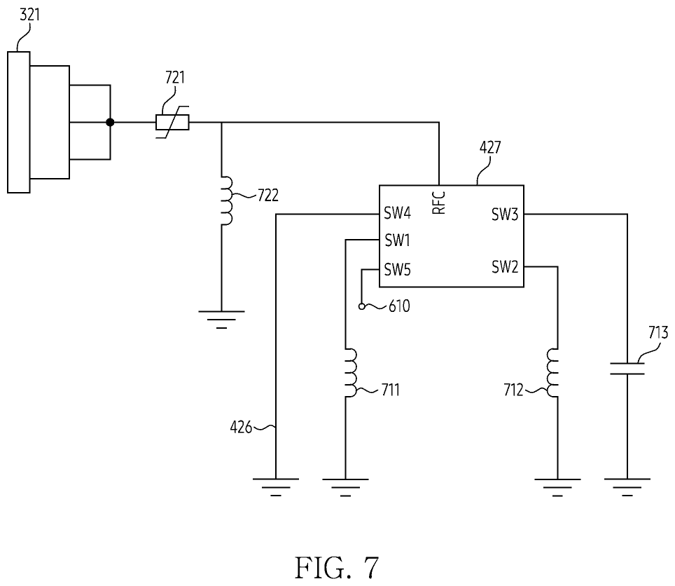

FIGS. 6 and 7 indicate a connection state between an antenna and a switch of an electronic device according to various embodiments of the disclosure.

Referring to FIG. 6, an electronic device 101 may include a second side wall 321 and a switch 427. The electronic device 101 may further include electrical elements 621 and 622 disposed in an electrical path between the second side wall 321 and the switch 427. A first electrical element 621 may be an electrical element for preventing overcurrent. For example, the first electrical element 621 may be a fuse or a varistor. A second electrical element 622 may be a passive element (e.g., an inductor or a capacitor) disposed in a discharge path. The second electrical element 622 may discharge static electricity from the second side wall 321. The first electrical element 621 and the second electrical element 622 may be omitted. However, it is not limited thereto, and the second electrical element 622 may be disposed in an electrical path between a grounding portion 426 and the switch 427.

According to an embodiment, the switch 427 may connect the second side wall 321 to the grounding portion 426, or may convert the second side wall 321 to a floating state. For example, the switch 427 may electrically connect the second side wall 321 to the grounding portion 426 by electrically connecting a first terminal SW1 of the switch 427. The switch 427 may float the second side wall 321, by electrically connecting a second terminal SW2 of the switch 427. For example, the switch 427 may float the second side wall 321, by electrically connecting the second side wall to a floating node 610 through the second terminal SW2. The floating may mean opening the second side wall 321 from the grounding portion 426. The floating may be referred to as an open state in that the second side wall 321 is not connected to other electrical elements.

According to an embodiment, the switch 427 may discharge the static electricity from the second side wall 321, by being connected to the first terminal SW1 in an unfolded state. The switch 427 may open the second side wall 32, by being connected to the second terminal SW2 in a folded state. For example, the switch 427 may provide the floating state of the second side wall 321.

Referring to FIG. 7, an electronic device 101 may include a second side wall 321 and a switch 427. The electronic device 101 may further include electrical elements 721 and 722 disposed in the electrical path between the second side wall 321 and the switch 427. A first electrical element 721 may be an electrical element for preventing the overcurrent. A second electrical element 722 may be a passive element disposed in the discharge path. The first electrical element 721 and the second electrical element 722 may be omitted. However, it is not limited thereto, and the second electrical element 722 may be disposed in the electrical path between the grounding portion 426 and the switch 427.

According to an embodiment, the switch 427 may connect the second side wall 321 to the grounding portion 426, convert the second side wall 321 to the floating state, or match impedance for an operation of an antenna radiator (e.g., the conductive portions 331, 332, 333, 334, and 335 of FIGS. 3A and 4A) operating as an antenna in the folded state.

The switch 427 may electrically connect the second side wall 321 to a first impedance matching element 711, by electrically connecting the first terminal SW1 of the switch 427. The switch 427 may electrically connect the second side wall 321 to a second impedance matching element 712, by electrically connecting the second terminal SW2 of the switch 427. The switch 427 may electrically connect the second side wall 321 to a third impedance matching element 713, by electrically connecting a third terminal SW3 of the switch 427. The switch 427 may electrically connect the second side wall 321 to the grounding portion 426, by electrically connecting a fourth terminal SW4 of the switch 427. The switch 427 may float the second side wall 321, by electrically connecting a fifth terminal SW5 of the switch 427. For example, the switch 427 may float the second side wall 321, by electrically connecting the second side wall to the floating node 610 through the fifth terminal SW5.

According to an embodiment, the switch 427 may be connected to one of impedance matching elements 711, 712, and 713 for an operation of at least one of the conductive portions 331, 332, 333, 334, and 335 operating as the antenna radiator in the folded state. For example, the impedance matching elements 711, 712, and 713 may be a passive element such as an inductor or a capacitor.

According to an embodiment, the switch 427 may match the impedance, by being connected to the first terminal SW1, the second terminal SW2, or the third terminal SW3 in the folded state. The switch 427 may discharge the static electricity from the second side wall 321, by being connected to the fourth terminal SW4 in the unfolded state. The switch 427 may open the second side wall 321, by being connected to the fifth terminal SW5 in the folded state. For example, the switch 427 may provide the floating state of the second side wall 321.

According to an embodiment, a processor (e.g., the processor 120 of FIG. 1) may electrically disconnect the second side wall 321 from the grounding portion 426 in the folded state of the electronic device 101. The processor 120 may be configured to electrically connect the second side wall 321 to the grounding portion 426 within the second housing 320 in the unfolded state of the electronic device 101. For example, the processor 120 may connect the switch 427 to the fifth terminal SW5 in the folded state. The processor 120 may be configured to connect the switch 427 to the fourth terminal SW4 in the unfolded state.

According to an embodiment, the processor 120 may be configured to electrically connect the second side wall 321 to one of the impedance matching elements 711, 712, and 713 disposed within the second housing 320 in the folded state. For example, the processor 120 may be configured to identify being electrically connected to at least one of the conductive portions 331, 332, 333, 334, and 335. The processor 120 may be configured to be electrically connected to one of the impedance matching elements 711, 712, and 713 corresponding to the at least one conductive portion, based on the identification.

According to an embodiment, the first conductive portion 331 may be configured to communicate a first signal in a first frequency band with an external electronic device. The second conductive portion 332 may be configured to communicate a second signal in a second frequency band different from the first frequency band with the external electronic device. The third conductive portion 333 may be configured to communicate a third signal in a third frequency band different from the first frequency band and the second frequency band with the external electronic device. The processor 120 may be electrically connected to the first conductive portion 331 to communicate with the external electronic device through the first conductive portion 331. For example, the processor may establish a communication channel with the external electronic device through the first conductive portion 331. The processor 120 may identify an electrical connection with the first conductive portion 331 or may be electrically connected to one of the impedance matching elements in response to the establishment of the communication channel. For example, the processor 120 may electrically connect the second side wall 321 to the first impedance matching element 711 for the impedance matching of the first conductive portion 331 configured to communicate the first signal in the first frequency band with the external electronic device.

According to an embodiment, the processor 120 may be electrically connected to the second conductive portion 332 to communicate with the external electronic device through the second conductive portion 332. For example, the processor may establish the communication channel with the external electronic device through the second conductive portion 332. The processor 120 may identify the electrical connection with the second conductive portion 332 or may be electrically connected to one of the impedance matching elements in response to the establishment of the communication channel. For example, the processor 120 may electrically connect the second side wall 321 to the second impedance matching element 712 for the impedance matching of the second conductive portion 332 configured to communicate the second signal in the second frequency band with the external electronic device.

According to an embodiment, the processor 120 may be electrically connected to the third conductive portion 333 to communicate with the external electronic device through the third conductive portion 333. For example, the processor 120 may establish the communication channel with the external electronic device through the third conductive portion 333. The processor 120 may identify the electrical connection with the third conductive portion 333 or may be electrically connected to one of the impedance matching elements in response to the establishment of the communication channel. For example, the processor 120 may electrically connect the second side wall 321 to the third impedance matching element 713 for impedance matching of the third conductive portion 333 configured to communicate the third signal in the third frequency band with the external electronic device.

According to the above-described embodiment, through the switch 427, the electronic device 101 may electrically disconnect the second side wall 321 from the grounding portion 426 when folded, and electrically connect the second side wall 321 to the grounding portion 426 when unfolded. In the folded state, the electronic device 101 may match the impedance through the impedance matching elements 711, 712, and 713, based on a characteristic of the conductive portion operating as the antenna radiator among the conductive portions 331, 332, 333, 334, and 335. The electronic device 101 may discharge the static electricity from the second side wall 321, through connection between the second side wall 321 and the grounding portion 426 in the unfolded state. The electronic device 101 may improve radiation performance of the conductive portions 331, 332, 333, 334, and 335 operating as the antenna radiator through electrical disconnection between the grounding portion 426 and the second side wall 321 in the folded state. The electronic device 101 may improve the radiation performance when communicating using the conductive portions 331, 332, 333, 334, and 335, based on matching the impedance.

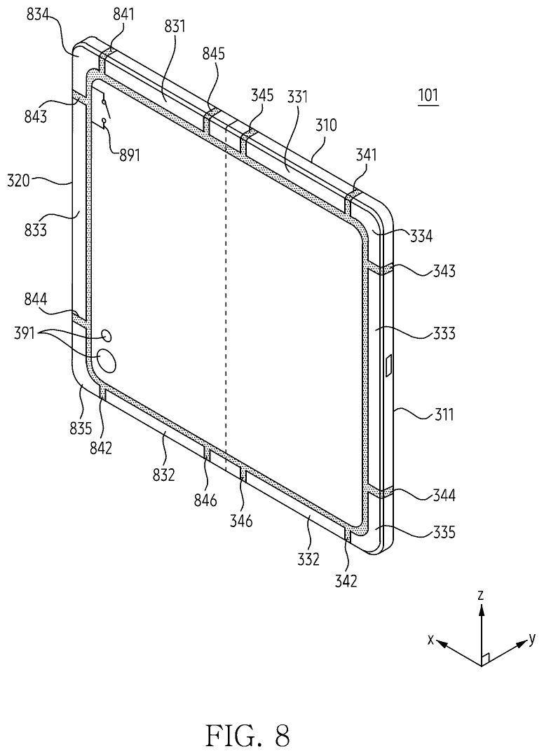

FIG. 8 indicates a disposition of a conductive portion and a non-conductive portion of an electronic device according to an embodiment of the disclosure.

Referring to FIG. 8, a first housing 310 may include a first side wall 311. The first side wall 311 may form a portion of an exterior of an electronic device 101. According to an embodiment, the first side wall 311 may include a plurality of conductive portions 331, 332, 333, 334, and 335 and a plurality of non-conductive portions 341, 342, 343, 344, 345, 346, 347, and 348. The plurality of non-conductive portions 341, 342, 343, 344, 345, and 346 may be disposed between the plurality of conductive portions 331, 332, 333, 334, and 335.

According to an embodiment, the plurality of non-conductive portions and the plurality of conductive portions may be the same as or similar to the plurality of non-conductive portions and the plurality of conductive portions of FIGS. 3A, 3B, 4A, 4B, 5A, and 5B. Content overlapping a description of the plurality of non-conductive portions and the plurality of conductive portions may be omitted.

According to an embodiment, the second housing 320 may include the second side wall 321. The second side wall 321 may form the portion of the exterior of the electronic device 101. The second side wall 321 may form a side surface of the second housing 320. According to an embodiment, the second side wall 321 may include a plurality of conductive portions 831, 832, 833, 834, and 835 and a plurality of non-conductive portions 841, 842, 843, 844, 845, and 846. The plurality of non-conductive portions 841, 842, 843, 844, 845, and 846 may be disposed between the plurality of conductive portions 831, 832, 833, 834, and 835. For example, a sixth conductive portion 831 may form at least a portion of a first edge of the second housing 320. A seventh conductive portion 832 may form at least a portion of a second edge facing the first edge of the second housing 320. An eighth conductive portion 833 may form at least a portion of a third edge of the second housing 320 disposed between the first edge and the second edge. A ninth conductive portion 834 may extend from the sixth conductive portion 831 to the eighth conductive portion 833. The ninth conductive portion 834 may form a portion of the first edge and a portion of the third edge. The tenth conductive portion 835 may extend from the seventh conductive portion 832 to the eighth conductive portion 833. A tenth conductive portion 835 may form a portion of the second edge and another portion of the third edge.

According to an embodiment, a ninth non-conductive portion 841 may be disposed between the sixth conductive portion 831 and the ninth conductive portion 834. A tenth non-conductive portion 842 may be disposed between the seventh conductive portion 832 and the tenth conductive portion 835. An eleventh non-conductive portion 843 may be disposed between the eighth conductive portion 833 and the ninth conductive portion 834. A twelfth non-conductive portion 844 may be disposed between the eighth conductive portion 833 and the tenth conductive portion 835.

According to an embodiment, the second housing 320 may include a segmented portion connected to the ninth non-conductive portion 841, the tenth non-conductive portion 842, the eleventh non-conductive portion 843, the twelfth non-conductive portion 844, a thirteenth non-conductive portion 845, and a fourteenth non-conductive portion 846.

The sixth conductive portion 831, the seventh conductive portion 832, the eighth conductive portion 833, the ninth conductive portion 834, and the tenth conductive portion 835 of the second housing 320 may be configured to correspond to the first conductive portion 331, the second conductive portion 332, the third conductive portion 333, the fourth conductive portion 334, and the fifth conductive portion 335 of the first housing 310. The conductive portions 831, 832, 833, 834, and 835 of the second housing 320 may be configured to correspond to a shape or a length of the conductive portions 331, 332, 333, 334, and 335 of the first housing 310. For example, in a folded state of the electronic device 101, the conductive portions 331, 332, 333, 334, and 335 of the first housing 310 may overlap the conductive portions 831, 832, 833, 834, and 835 of the second housing 320.

In order to reduce coupling with the conductive portions 331, 332, 333, 334, and 335 of the first housing 310 used as an antenna radiator, the second housing 320 may include segmented conductive portions 831, 832, 833, 834, and 835. The conductive portions 831, 832, 833, 834, and 835 of the second housing 320 may be electrically connected to each other, by using a switch 891. The switch 891 may be configured to electrically connect the entire conductive portions 831, 832, 833, 834, and 835 of the second housing 320. For example, the switch 891 may be configured to electrically connect the entire conductive portions 831, 832, 833, 834, and 835 of the second housing 320 or to electrically connect a portion of the conductive portions 831, 832, 833, 834, and 835 of the second housing 320. The switch 891 is connected to the eighth conductive portion 833 and the ninth conductive portion 834, but is not limited thereto. The switch 891 may include a switch connectable to the entire conductive portions 831, 832, 833, 834, and 835. The switch 891 may include a plurality of switches connecting the portion of the conductive portions 831, 832, 833, 834, and 835.

According to an embodiment, the electronic device 101 may further include the optical input device 391 disposed in the second housing 320. However, a position of the optical input device 391 is not limited thereto. For example, the optical input device 391 may be disposed on the first housing 310 or the second housing 320.

According to an embodiment, as the first housing 310 and the second housing 320 of the electronic device 101 (e.g., the electronic device 101 of FIG. 3A) in an unfolded state do not face each other, and form a plane, the conductive portions 331, 332, 333, 334, and 335 may not overlap the conductive portions 831, 832, 833, 834, and 835. At least a portion of the conductive portions 331, 332, 333, 334, and 335 may operate as the antenna radiator. In the unfolded state, the conductive portions 331, 332, 333, 334, and 335 operating as the antenna radiator may be relatively less affected by the conductive portions 831, 832, 833, 834, and 835 than in the folded state. In the folded state, to reduce the influence of the conductive portions 831, 832, 833, 834, and 835 on the conductive portions 331, 332, 333, 334, and 335 that function as the antenna radiators, the conductive portions 831, 832, 833, 834, and 835 may be electrically isolated or floated from the grounding portion. The conductive portions 831, 832, 833, 834, and 835 configured to be segmented from each other may be electrically connected to each other. The conductive portions 831, 832, 833, 834, and 835 electrically connected to each other may operate in the same manner as the second side wall 321 of FIGS. 3A, 4A, or 5A.

According to the above-described embodiment, by separating the conductive portions 831, 832, 833, 834, and 835 of the second side wall 321 from each other, coupling between the conductive portions 831, 832, 833, 834, and 835 of the second side wall 321 and the conductive portions 331, 332, 333, 334, and 335 of the first housing 310 operating as the antenna radiator may be reduced. Since the second side wall 321 reduces current induced from the conductive portions 331, 332, 333, 334, and 335, by electrically disconnecting the conductive portions 831, 832, 833, 834, and 835 from the grounding portion as needed, radiation performance of the conductive portions 331, 332, 333, 334, and 335 may be improved.

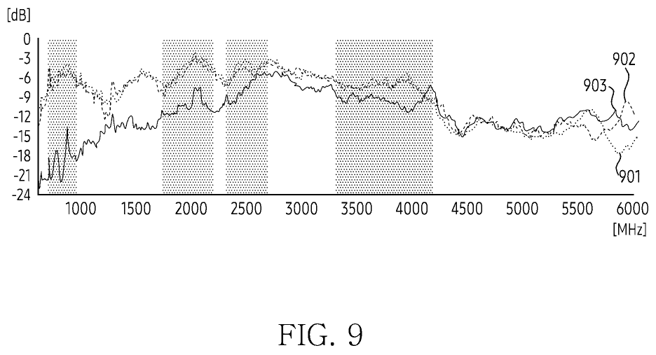

FIG. 9 indicates graphs indicating antenna performance of electronic devices according to an embodiment of the disclosure.

Referring to FIG. 9, a first graph 901, a second graph 902, and a third graph 903 indicate radiation performance of conductive portions 331, 332, 333, 334, and 335 of the first housing 310 operating as an antenna radiator according to a configuration of a second side wall 321. An x-axis may indicate a frequency, and a unit of the x-axis may be MHz. A y-axis may indicate a response characteristic according to a frequency, and a unit of the y-axis may be decibels (dB). The frequency may be a frequency of a signal provided for communicating with an external electronic device. The response characteristic may indicate a magnitude of an output signal compared to an input signal.

The first graph 901 indicates a response characteristic in an unfolded state. The second graph 902 indicates a response characteristics in a folded state of the electronic device including the second side wall 321 integrally formed and segmented from the grounding portion, or the conductive portions 831, 832, 833, 834 of the second housing 320 segmented from the grounding portion. The third graph 903 indicates a response characteristic in the folded state of the electronic device including the second side wall 321 connected to the grounding portion or the conductive portions 831, 832, 833, 834, and 835 of the second housing 320 connected to the grounding portion.

The response characteristic of the first graph 901 and the second graph 902 may be higher than the response characteristics of the third graph 903 within a shaded frequency band (e.g., low band, mid band, high band, ultra-high band).

According to an embodiment, in case that the second side wall 321 or the conductive portions 831, 832, 833, 834, and 835 of the second housing 320 are in a floating state after being segmented from the grounding portion, radiation efficiency of the antenna radiator using the conductive portions 331, 332, 333, 334, and 335 may be high.

According to the above-described embodiment, an electronic device (e.g., the electronic device 101 of FIG. 4A) may include a first housing (e.g., the first housing 310 of FIG. 4A), a second housing (e.g., the second housing 320 of FIG. 4A), and a hinge structure (e.g., the hinge structure 490 of FIG. 4A). The first housing may include conductive portions (e.g., the conductive portions 331, 332, and 333 of FIG. 4A) and non-conductive portions (e.g., the non-conductive portions 441 and 442 of FIG. 4A). The conductive portions may be spaced apart from each other. The non-conductive portions may be disposed between the conductive portions. The second housing may include a conductive side wall (e.g., the second side wall 321 of FIG. 4A). The conductive side wall may have a length substantially equal to a length of the side wall. The hinge structure may rotatably connect the first housing and the second housing. According to an embodiment, the electronic device may include a grounding portion (e.g., the grounding portion 426 of FIG. 4A) and a processor (e.g., the processor 416 of FIG. 4A). According to an embodiment, the grounding portion may be disposed within the second housing. According to an embodiment, the processor may be disposed within the first housing. The processor may be electrically connected to an antenna radiator for communicating with an external electronic device. The antenna radiator may use at least one of the conductive portions.

According to an embodiment, the processor may be configured to electrically disconnect the conductive side wall from the grounding portion in a folded state in which a first surface of the first housing and a second surface of the second housing face different directions.

According to an embodiment, the processor may be configured to electrically connect the conductive side wall to the grounding portion within the second housing in an unfolded state in which a direction faced by the first surface and a direction faced by the second surface are the same.

According to the above-described embodiment, through a switch, the electronic device may electrically disconnect the conductive side wall from the grounding portion when folded, and electrically connect the conductive side wall to the grounding portion when unfolded. The electronic device may discharge static electricity of the conductive side wall, through connection between the second side wall and the grounding portion in the folded state. The electronic device may improve radiation performance of the conductive portions operating as the antenna radiator through electrical disconnection between the grounding portion and the second side wall in the unfolded state.

According to an embodiment, the processor may be configured to electrically connect the conductive side wall to one of passive elements (e.g., the impedance matching elements 711, 712, and 713 of FIG. 7) disposed within the second housing in the folded state.

According to the above-described embodiment, in a folded state, the electronic device may match impedance through the impedance matching elements, based on a characteristic of a conductive portion operating as the antenna radiator among the conductive portions. The electronic device may improve the radiation performance when communicating using the conductive portions, based on matching impedance.

According to an embodiment, the processor may be configured to establish a communication channel with the external electronic device (e.g., the electronic device 104 of FIG. 1) through at least one of the conductive portions. According to an embodiment, the processor may be configured to electrically connect one of the passive elements corresponding to the at least one conductive portion based on the establishment of the communication channel.

According to the above-described embodiment, in the folded state, the electronic device may match the impedance with an impedance matching element corresponding to the conductive portion operating as the antenna radiator among the conductive portions through an electrical connection. The electronic device may improve the radiation performance when communicating using the conductive portions, based on matching the impedance.

According to an embodiment, the electronic device may include a flexible display (e.g., the display 430 of FIG. 4A) and a display (e.g., the external display 510 of FIG. 5A).

According to an embodiment, the flexible display may be disposed on the first surface and the second surface.

According to an embodiment, the display may be disposed on a surface of the second housing opposite to the second surface.

According to an embodiment, when viewing the display from above, an edge of the display may be spaced apart from the conductive portions.

According to the above-described embodiment, the electronic device 101 may reduce influence of an antenna due to noise of the external display by disposing the display and the conductive portions in a different housing. By connecting or disconnecting the conductive side wall to the grounding portion according to the unfolded state and the folded state, the electronic device may discharge static electricity in the unfolded state and improve the radiation performance of the antenna in the folded state.

According to an embodiment, a portion of the side wall from among the side wall of the first housing and the conductive side wall of the second housing may be configured to operate as a radiator of the antenna for communicating with the external electronic device.

According to an embodiment, in the folded state, the conductive portions and the non-conductive portions, when viewing the first housing from above, may overlap the conductive side wall.

According to the above-described embodiment, in the electronic device, the conductive side wall where a grounding portion 426 is disconnected when folded may improve the radiation performance of the conductive portions. Even if the conductive side wall disconnected from the grounding portion 426 overlaps the conductive portions, a change in antenna performance may be reduced.

According to an embodiment, the conductive side wall may be connected to an electrical path that discharges current of the conductive side wall to the grounding portion.

According to an embodiment, the conductive portions may include a first conductive portion (e.g., the first conductive portion 331 of FIG. 4A) connected to the hinge structure, a second conductive portion (e.g., the second conductive portion 332 of FIG. 4A), connected to the hinge structure, facing the first conductive portion, and a third conductive portion (e.g., the third conductive portion 333 of FIG. 4A) disposed between the first conductive portion, and the second conductive portion.

According to an embodiment, the non-conductive portions may include a first non-conductive portion (e.g., a first non-conductive portion 441 of FIG. 4A) disposed between the first conductive portion and the third conductive portion, and a second non-conductive portion (e.g., a second non-conductive portion 442 of FIG. 4A) disposed between the second conductive portion and the third conductive portion.

According to an embodiment, the first conductive portion may be configured to communicate a first signal in a first frequency band with an external electronic device.

According to an embodiment, the second conductive portion may be configured to communicate a second signal in a second frequency band different from the first frequency band with the external electronic device.

According to an embodiment, the third conductive portion may be configured to communicate a third signal in a third frequency band different from the first frequency band and the second frequency band with the external electronic device.

According to an embodiment, the second conductive portion from among the first conductive portion, the second conductive portion, and the third conductive portion may be configured to communicate a second signal in a second frequency band with the external electronic device.

According to an embodiment, the first conductive portion and the third conductive portion from among the first conductive portion, the second conductive portion, and the third conductive portion may be configured to be electrically disconnected from the processor.

According to an embodiment, the electronic device may further comprise a switch. The switch may be configured to electrically connect the conductive side wall and the grounding portion in the unfolded state, and electrically disconnect the conductive side wall and the grounding portion in the folded state.

According to an embodiment, the switch may be configured to electrically connect one of the passive elements disposed between the conductive side wall and the grounding portion in the folded state.

According to an embodiment, the electronic device may further comprise a segmented portion. The segmented portion may be spaced apart from the conductive side wall and disposed along the conductive side wall.

According to an embodiment, a portion of the second housing surrounded by the segmented portion may be electrically connected to the grounding portion.

According to the above-described embodiment, the segmented portion may segment the portion of the second housing from the conductive side wall. By being segmented from the portion of the second housing used as the grounding portion, current induced from the conductive portions used as the antenna radiator to the conductive side wall may be reduced. Based on the reduction in the induced current, the radiation performance of the antenna radiator may be improved.

According to an embodiment, in the folded state, the conductive side wall may be configured to be electrically disconnected from a portion of the second housing.

According to an embodiment, in the unfolded state, the conductive side wall may be configured to be electrically connected to a portion of the second housing.

According to an embodiment, the electronic device may further comprise a first printed circuit board (e.g., the first printed circuit board 410 of FIG. 4A), and a second printed circuit board (e.g., the second printed circuit board 420 of FIG. 4A).

According to an embodiment, the first printed circuit board, on which the processor is disposed, may be disposed within the first housing.

According to an embodiment, the second printed circuit board, on which the grounding portion is disposed, and disposed within the second housing, may be further included.

According to the above-described embodiment, the grounding portion disposed within the second housing may be electrically connected to the conductive side wall in the unfolded state, and may be electrically segmented from the conductive side wall in the folded state. In the unfolded state, the conductive side wall may discharge residual current in the unfolded state, and the current induced from the radiator to the conductive side wall in the folded state may be reduced.

According to an embodiment, an electronic device (e.g., the electronic device 101 of FIG. 4A) may include a first housing (e.g., the first housing 310 of FIG. 4A), a second housing (e.g., the second housing 320 of FIG. 4A), and a hinge structure (e.g., the hinge structure 490 of FIG. 4A).

According to an embodiment, the first housing may include a side wall (e.g., the first side wall 311 of FIG. 4A), the side wall including a first conductive portion (e.g., the first conductive portion 331 of FIG. 4A), a second conductive portion (e.g., the second conductive portion 332 of FIG. 4A) facing the first conductive portion, and a third conductive portion (e.g., the third conductive portion 333 of FIG. 4A) disposed between the first conductive portion and the second conductive portion and spaced apart from the first conductive portion and the second conductive portion.

According to an embodiment, the second housing may include a conductive side wall (e.g., the second side wall 321 of FIG. 4A) having a length substantially equal to a length of the side wall.

According to an embodiment, the hinge structure may be configured to rotatably connect the first housing and the second housing.

According to an embodiment, the electronic device may include a grounding portion (e.g., the grounding portion 426 of FIG. 4A), a switch (e.g., the switch 427 of FIG. 4A), and a processor (e.g., the processor 416 of FIG. 4A).

According to an embodiment, the grounding portion may be disposed within the second housing. According to an embodiment, the switch may be electrically connected to each of the grounding portion and the conductive side wall.

According to an embodiment, the processor may be disposed within the first housing, and electrically connected to the first conductive portion, the second conductive portion, or the third conductive portion which operate as a radiator of an antenna for communicating with an external electronic device (e.g., the electronic device 104 of FIG. 1).

According to an embodiment, the processor may be configured to electrically disconnect the conductive side wall from the grounding portion through the switch in a folding state in which a first surface of the first housing and a second surface of the second housing face different directions.

According to an embodiment, the processor may be configured to electrically connect the conductive side wall to the grounding portion within the second housing through the switch in an unfolding state in which a direction faced by the first surface and a direction faced by the second surface are the same.

According to the above-described embodiment, through the switch, the electronic device may electrically disconnect the conductive side wall from the grounding portion when folded and electrically connect the conductive side wall to the grounding portion when unfolded. The electronic device may discharge static electricity from the conductive side wall, through connection between a second side wall and the grounding portion in the folded state. The electronic device may improve radiation performance of conductive portions operating as the antenna radiator through electrical disconnection between the grounding portion and the second side wall in the unfolded state.

According to an embodiment, the processor may be configured to electrically connect the conductive side wall to one of passive elements (e.g., impedance matching elements 711, 712, and 713 of FIG. 7) disposed within the second housing in the folded state.

According to an embodiment, in the folded state, the first conductive portion, the second conductive portion, and the third conductive portion may overlap the conductive side wall when viewing the first housing from above.

According to an embodiment, the electronic device may further comprise a flexible display (e.g., the display 430 of FIG. 4A) disposed on the first surface and the second surface and a display (e.g., the external display 510 of FIG. 5A) disposed on a surface of the second housing opposite to the second surface.

According to an embodiment, an edge of the display, when viewing the display from above, may be spaced apart from the first conductive portion, the second conductive portion, and the third conductive portion.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means”.

What is claimed is:

1. An electronic device comprising:
a first housing including a side wall that includes conductive portions spaced apart from each other and non-conductive portions disposed between the conductive portions;
a second housing including a conductive side wall having a length substantially equal to a length of the side wall;
a hinge structure rotatably connecting the first housing and the second housing;
a grounding portion disposed within the second housing;
memory storing one or more computer programs; and
one or more processors disposed within the first housing and being electrically connected to at least one of the conductive portions operating as a radiator of an antenna for communicating with an external electronic device,
wherein the one or more computer programs include computer-executable instructions that, when executed by the one or more processors individually or collectively, cause the electronic device to:
electrically disconnect the conductive side wall from the grounding portion within the second housing when the electronic device is in a folded state in which a first surface of the first housing and a second surface of the second housing face different directions, and
electrically connect the conductive side wall to the grounding portion within the second housing when the electronic device is in an unfolded state in which a direction faced by the first surface and a direction faced by the second surface are a same direction.

2. The electronic device of claim 1, wherein the one or more computer programs further include computer-executable instructions that, when executed by the one or more processors individually or collectively, cause the electronic device to:
electrically connect the conductive side wall to one of passive elements disposed within the second housing when the electronic device is in the folded state.

3. The electronic device of claim 2, wherein the one or more computer programs further include computer-executable instructions that, when executed by the one or more processors individually or collectively, cause the electronic device to:
establish a communication channel with the external electronic device through at least one conductive portion among the conductive portions, and
electrically connect one of the passive elements corresponding to the at least one conductive portion based on the establishing of the communication channel.

4. The electronic device of claim 1, further comprising:
a flexible display disposed on the first surface and the second surface; and
a display disposed on a surface of the second housing opposite to the second surface.

5. The electronic device of claim 4, wherein, when viewing the display from above, an edge of the display is spaced apart from the conductive portions.

6. The electronic device of claim 1, wherein a portion of the side wall from among the side wall of the first housing and the conductive side wall of the second housing is configured to operate as the radiator of the antenna for communicating with the external electronic device.

7. The electronic device of claim 1, wherein, when the electronic device is in the folded state, the conductive portions and the non-conductive portions overlap the conductive side wall when viewing the first housing from above.

8. The electronic device of claim 1, wherein the conductive side wall is connected to an electrical path that discharges current of the conductive side wall to the grounding portion.

9. The electronic device of claim 1,
wherein the conductive portions includes:
a first conductive portion connected to the hinge structure,
a second conductive portion connected to the hinge structure and facing the first conductive portion, and
a third conductive portion disposed between the first conductive portion and the second conductive portion, and
wherein the non-conductive portions include:
a first non-conductive portion disposed between the first conductive portion and the third conductive portion, and
a second non-conductive portion disposed between the second conductive portion and the third conductive portion.

10. The electronic device of claim 9,
wherein the first conductive portion is configured to communicate a first signal in a first frequency band with the external electronic device,
wherein the second conductive portion is configured to communicate a second signal in a second frequency band different from the first frequency band with the external electronic device, and
wherein the third conductive portion is configured to communicate a third signal in a third frequency band different from the first frequency band and the second frequency band with the external electronic device.

11. The electronic device of claim 9,
wherein the second conductive portion is configured to communicate a second signal in a second frequency band with the external electronic device, and
wherein the first conductive portion and the third conductive portion are configured to be electrically disconnected from the one or more processors.

12. The electronic device of claim 1, further comprising:
a switch that electrically connects the conductive side wall and the grounding portion when the electronic device is in the unfolded state, and electrically disconnects the conductive side wall and the grounding portion when the electronic device is in the folded state.

13. The electronic device of claim 12, wherein the switch is configured to electrically connect one of passive elements disposed between the conductive side wall and the grounding portion when the electronic device is in the folded state.

14. The electronic device of claim 1, further comprising:
a segmented portion spaced apart from the conductive side wall and being disposed along the conductive side wall,
wherein a portion of the second housing surrounded by the segmented portion is electrically connected to the grounding portion.

15. The electronic device of claim 1,
wherein, when the electronic device is in the folded state, the conductive side wall is configured to be electrically disconnected from a portion of the second housing, and
wherein, when the electronic device is in the unfolded state, the conductive side wall is configured to be electrically connected to the portion of the second housing.

16. The electronic device of claim 1, further comprising:
a first printed circuit board disposed within the first housing, the one or more processors being disposed on the first printed circuit board; and
a second printed circuit board disposed within the second housing, the grounding portion being disposed on the second printed circuit board.

17. An electronic device comprising:
a first housing including a side wall, the side wall including a first conductive portion, a second conductive portion facing the first conductive portion, and a third conductive portion disposed between the first conductive portion and the second conductive portion and spaced apart from the first conductive portion and the second conductive portion;
a second housing including a conductive side wall having a length substantially equal to a length of the side wall;
a hinge structure rotatably connecting the first housing and the second housing;
a grounding portion disposed within the second housing;
a switch electrically connected to each of the grounding portion and the conductive side wall;
memory storing one or more computer programs; and
one or more processors disposed within the first housing and being electrically connected to at least one of the first conductive portion, the second conductive portion, or the third conductive portion which operates as a radiator of an antenna for communicating with an external electronic device,
wherein the one or more computer programs include computer-executable instructions that, when executed by the one or more processors individually or collectively, cause the electronic device to:
electrically disconnect the conductive side wall from the grounding portion within the second housing through the switch when the electronic device is in a folding state in which a first surface of the first housing and a second surface of the second housing face different directions, and
electrically connect the conductive side wall to the grounding portion within the second housing through the switch when the electronic device is in an unfolding state in which a direction faced by the first surface and a direction faced by the second surface are a same direction.

18. The electronic device of claim 17, wherein the one or more computer programs further include computer-executable instructions that, when executed by the one or more processors individually or collectively, cause the electronic device to:
electrically connect the conductive side wall to one of passive elements disposed within the second housing when the electronic device is in the folding state.

19. The electronic device of claim 18, wherein, when the electronic device is in the folded state, the first conductive portion, the second conductive portion, and the third conductive portion overlap the conductive side wall when viewing the first housing from above.

20. One or more non-transitory computer-readable storage media storing one or more computer programs including computer-executable instructions that, when executed by one or more processors of an electronic device individually or collectively, cause the electronic device to perform operations, the electronic device including a first housing including a side wall that includes conductive portions spaced apart from each other and non-conductive portions disposed between the conductive portions, a second housing including a conductive side wall having a length substantially equal to a length of the side wall, a hinge structure rotatably connecting the first housing and the second housing, and a grounding portion disposed within the second housing, the operations comprising:
electrically disconnecting the conductive side wall from the grounding portion within the second housing when the electronic device is in a folded state in which a first surface of the first housing and a second surface of the second housing face different directions; and
electrically connecting the conductive side wall to the grounding portion within the second housing when the electronic device is in an unfolded state in which a direction faced by the first surface and a direction faced by the second surface are a same direction.
